(19) United States
(12) Patent Application Publication
(10) Pub. No.: US 2026/0181701 A1
(43) Pub. Date: Jun. 25, 2026

(54) INITIAL ACCESS PROCEDURE ASSISTANCE INFORMATION

(71) Applicant: InterDigital Patent Holdings, Inc., Wilmington, DE (US)

(72) Inventors: Keiichi Kubota, Tokyo (JP); Umer Salim, Vallauris (FR); Brian Martin, Farnham (GB); Moon IL Lee, Melville, NY (US)

(73) Assignee: InterDigital Patent Holdings, Inc., Wilmington, DE (US)

(21) Appl. No.: 18/990,515

(22) Filed: Dec. 20, 2024

(51) Int. Cl. H04W 74/0833; H04B 17/318; H04W 72/1268; H04W 72/51; H04W 76/20

(52) U.S. Cl. CPC H04W 74/0833; H04B 17/328; H04W 72/1268; H04W 72/51; H04W 76/20

(57) ABSTRACT

Disclosed herein are systems, methods, and instrumentalities associated with initial access procedure assistance information. A wireless transmit/receive unit (WTRU) may receive, from a network node, a grant of an uplink resource. The WTRU may determine assistance information associated with a downlink transmission. The assistance information may include one or more of: an indication of a capability of the WTRU to receive a repetition of the downlink transmission, an indication of a number of repetitions of the downlink transmission, an indication that the WTRU satisfies a condition, an indication of a downlink measurement, or an indication of location information associated with the WTRU. The WTRU may send, to the network node, an uplink transmission via the uplink resource. The uplink transmission may indicate the assistance information. The uplink transmission may be associated with an initial access procedure. The WTRU may receive the downlink transmission from the network node.

### BACKGROUND

A wireless communication system may experience different channel conditions, power levels, and/or reliability requirements. Systems and methods that take these factors into account may improve the performance and efficiency of the communication system.

### SUMMARY

Disclosed herein are systems, methods, and instrumentalities associated with initial access procedure assistance information. According to embodiments of the disclosure, a wireless transmit/receive unit (WTRU) may be configured to receive, from a network node, a grant of an uplink resource. The WTRU may determine assistance information associated with a downlink transmission. The assistance information may include one or more of: an indication of a capability of the WTRU to receive a repetition of the downlink transmission, an indication of a number of repetitions of the downlink transmission, an indication that the WTRU satisfies a condition, an indication of a downlink measurement, or an indication of location information associated with the WTRU. The WTRU may send, to the network node, an uplink transmission via the uplink resource. The uplink transmission may indicate the assistance information. The uplink transmission may be associated with an initial access procedure. The WTRU may receive the downlink transmission from the network node. The downlink transmission may be associated with the initial access procedure.

The downlink transmission associated with the initial access procedure may include a physical downlink shared channel (PDSCH) transmission carrying Msg4. The uplink transmission may include a physical uplink shared channel (PUSCH) transmission carrying Msg3. The downlink transmission may be transmitted in accordance with the assistance information.

The assistance information may indicate one or more of: a number of times to repeat the downlink transmission; a minimum number of times to repeat the downlink transmission; a maximum number of times to repeat the downlink transmission; that a reference signal received power (RSRP) level satisfies an RSRP threshold; that a reference signal received quality (RSRQ) level satisfies an RSRQ threshold; that the RSRQ level is within a range of RSRQ levels; a transport block size for the downlink transmission; a modulation and coding scheme; or whether to split the downlink transmission into more than one transport block.

The WTRU may determine the assistance information based on one or more of: system information received from the network node; a capability of the WTRU to receive repetitions of the downlink transmission; a downlink measurement satisfying a threshold; a number of repetitions associated with physical random access channel (PRACH) or physical uplink shared channel (PUSCH) transmissions; whether the network node is employing an energy saving mechanism; whether the network node is employing a beam hopping mechanism; whether the network node is operating with wide satellite beams; whether the network node is operating with narrow satellite beams; or satellite ephemeris information.

The uplink transmission may indicate the assistance information via: a delta value associated with demodulation reference signal (DMRS) sequence initialization; a time position of an orthogonal frequency division multiplexing (OFDM) symbol associated with DMRS; a location of a frequency domain resource element associated with DMRS; a scrambling sequence used to scramble data in the uplink transmission; or cyclic redundancy check (CRC) bits in the uplink transmission.

The uplink transmission may indicate the assistance information via: a logical channel identifier (LCID) in a medium access control (MAC) sub-header; a spare bit in a radio resource control (RRC) setup request message in the uplink transmission; or an establishment cause value in the RRC setup request message in the uplink transmission.

The assistance information may include first information and second information. The uplink transmission may indicate the first information via lower layer signaling. The uplink transmission may indicate the second information via higher layer signaling. The initial access procedure may be a four-step random access channel procedure.

The WTRU may receive system information from the network. The WTRU may determine that the WTRU supports a feature associated with assistance information. The WTRU may determine the assistance information associated with the downlink transmission based on the system information.

### BRIEF DESCRIPTION OF THE DRAWINGS

FIG. 1A is a system diagram illustrating an example communications system in which one or more disclosed embodiments can be implemented.

FIG. 1B is a system diagram illustrating an example wireless transmit/receive unit (WTRU) that can be used within the communications system illustrated in FIG. 1A according to an embodiment.

FIG. 1C is a system diagram illustrating an example radio access network (RAN) and an example core network (CN) that can be used within the communications system illustrated in FIG. 1A according to an embodiment.

FIG. 1D is a system diagram illustrating a further example RAN and a further example CN that can be used within the communications system illustrated in FIG. 1A according to an embodiment.

FIG. 2 illustrates examples of network layers (e.g., non-terrestrial network (NTN) and/or terrestrial network (TN) layers).

FIG. 3 illustrates example radio interfaces established in NTNs.

FIG. 4 illustrates an example of a WTRU determining assistance information based on condition(s)/configuration(s) indicated in system information.

FIG. 5 illustrates an example of a WTRU sending initial access procedure assistance information, where one or more of the illustrated actions may be performed.

### DETAILED DESCRIPTION

A more detailed understanding can be had from the following description, given by way of example in conjunction with the accompanying drawings.

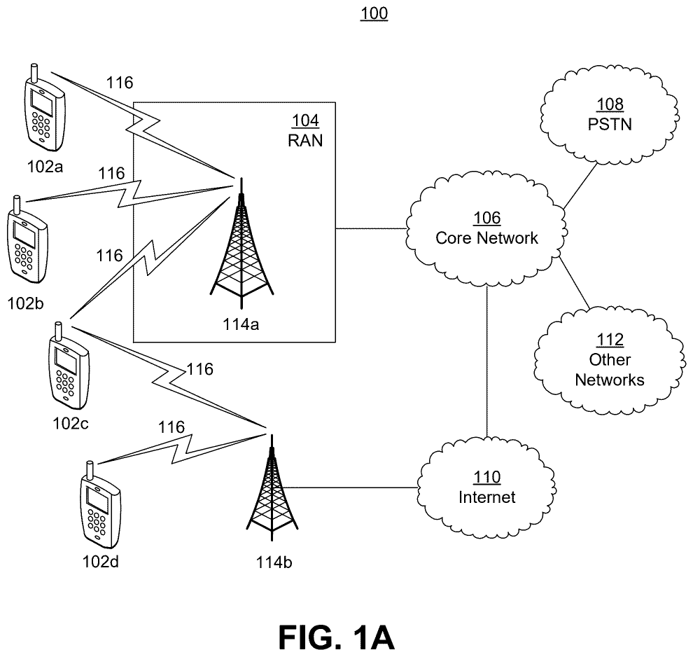

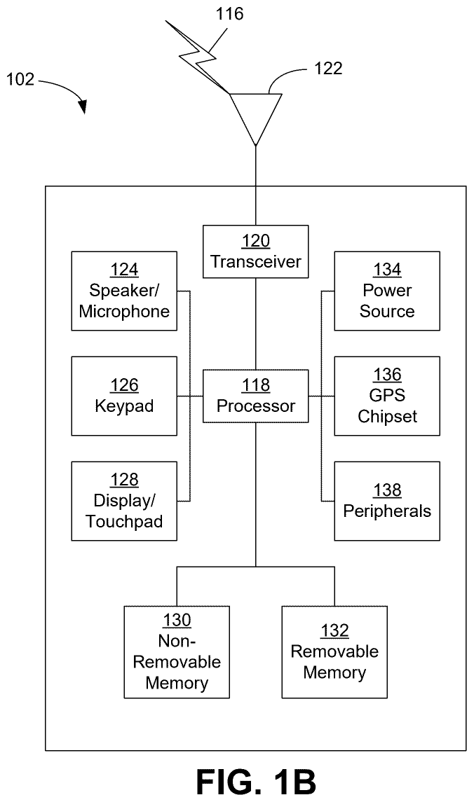

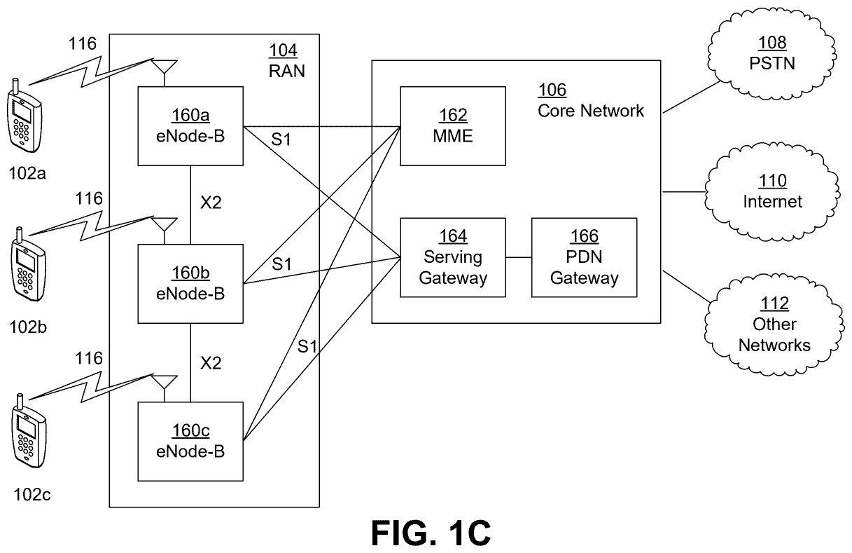

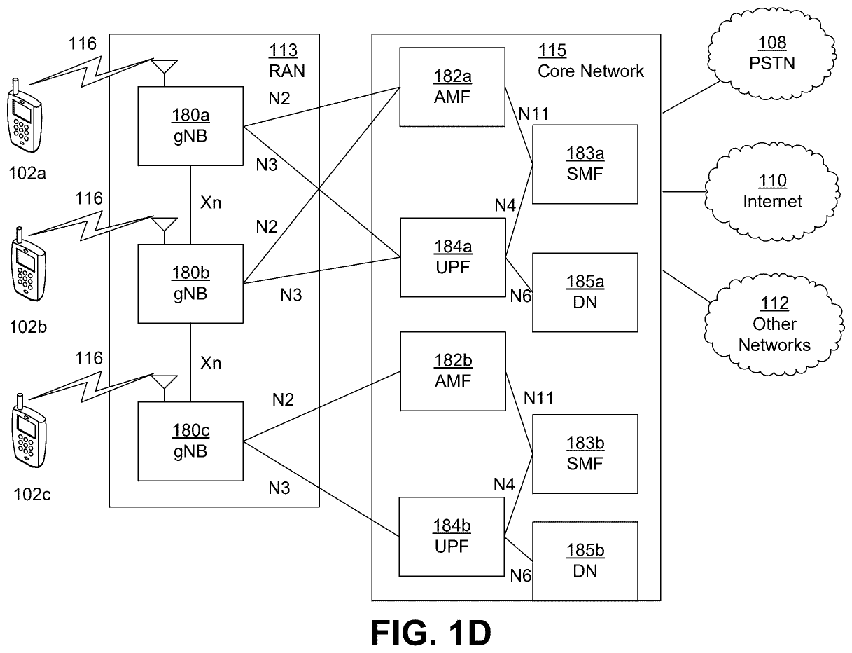

FIG. 1A is a diagram illustrating an example communications system 100 in which one or more disclosed embodiments can be implemented. The communications system 100 can be a multiple access system that provides content, such as voice, data, video, messaging, broadcast, etc., to multiple wireless users. The communications system 100 can enable multiple wireless users to access such content through the sharing of system resources, including wireless bandwidth. For example, the communications systems 100 can employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 can include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d can be any type of device configured to operate and/or communicate in a wireless environment. By way of example, the WTRUs 102a, 102b, 102c, 102d, any of which can be referred to as a “station” and/or a “STA”, can be configured to transmit and/or receive wireless signals and can include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d can be interchangeably referred to as a WTRU.

The communications systems 100 can include a base station 114a and/or a base station 114b. Each of the base stations 114a, 114b can be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b can be a base transceiver station (BTS), a Node-B, an eNode B, a Home Node B, a Home eNode B, a base station, a NR NodeB, a site controller, an access point (AP), a wireless router, and the like. While the base stations 114a, 114b are each depicted as a single element, it will be appreciated that the base stations 114a, 114b can include any number of interconnected base stations and/or network elements.

The base station 114a can be part of the RAN 104/113, which can also include other base stations and/or network elements (not shown), such as a base station controller (BSC), a radio network controller (RNC), relay nodes, etc. The base station 114a and/or the base station 114b can be configured to transmit and/or receive wireless signals on one or more carrier frequencies, which can be referred to as a cell (not shown). These frequencies can be in licensed spectrum, unlicensed spectrum, or a combination of licensed and unlicensed spectrum. A cell can provide coverage for a wireless service to a specific geographical area that can be relatively fixed or that can change over time. The cell can further be divided into cell sectors. For example, the cell associated with the base station 114a can be divided into three sectors. Thus, in one embodiment, the base station 114a can include three transceivers, i.e., one for each sector of the cell. In an embodiment, the base station 114a can employ multiple-input multiple output (MIMO) technology and can utilize multiple transceivers for each sector of the cell. For example, beamforming can be used to transmit and/or receive signals in desired spatial directions.

The base stations 114a, 114b can communicate with one or more of the WTRUs 102a, 102b, 102c, 102d over an air interface 116, which can be any suitable wireless communication link (e.g., radio frequency (RF), microwave, centimeter wave, micrometer wave, infrared (IR), ultraviolet (UV), visible light, etc.). The air interface 116 can be established using any suitable radio access technology (RAT).

More specifically, as noted above, the communications system 100 can be a multiple access system and can employ one or more channel access schemes, such as CDMA, TDMA, FDMA, OFDMA, SC-FDMA, and the like. For example, the base station 114a in the RAN 104/113 and the WTRUs 102a, 102b, 102c can implement a radio technology such as Universal Mobile Telecommunications System (UMTS) Terrestrial Radio Access (UTRA), which can establish the air interface 115/116/117 using wideband CDMA (WCDMA). WCDMA can include communication protocols such as High-Speed Packet Access (HSPA) and/or Evolved HSPA (HSPA+). HSPA can include High-Speed Downlink (DL) Packet Access (HSDPA) and/or High-Speed UL Packet Access (HSUPA).

In an embodiment, the base station 114a and the WTRUs 102a, 102b, 102c can implement a radio technology such as Evolved UMTS Terrestrial Radio Access (E-UTRA), which can establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c can implement a radio technology such as NR Radio Access, which can establish the air interface 116 using New Radio (NR).

In an embodiment, the base station 114a and the WTRUs 102a, 102b, 102c can implement multiple radio access technologies. For example, the base station 114a and the WTRUs 102a, 102b, 102c can implement LTE radio access and NR radio access together, for instance using dual connectivity (DC) principles. Thus, the air interface utilized by WTRUs 102a, 102b, 102c can be characterized by multiple types of radio access technologies and/or transmissions sent to/from multiple types of base stations (e.g., a eNB and a base station).

In other embodiments, the base station 114a and the WTRUs 102a, 102b, 102c can implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A can be a wireless router, Home Node B, Home eNode B, or access point, for example, and can utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d can implement a radio technology such as IEEE 802.11 to establish a wireless local area network (WLAN). In an embodiment, the base station 114b and the WTRUs 102c, 102d can implement a radio technology such as IEEE 802.15 to establish a wireless personal area network (WPAN). In yet another embodiment, the base station 114b and the WTRUs 102c, 102d can utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b can have a direct connection to the Internet 110. Thus, the base station 114b can not be required to access the Internet 110 via the CN 106/115.

The RAN 104/113 can be in communication with the CN 106/115, which can be any type of network configured to provide voice, data, applications, and/or voice over internet protocol (VoIP) services to one or more of the WTRUs 102a, 102b, 102c, 102d. The data can have varying quality of service (QoS) requirements, such as differing throughput requirements, latency requirements, error tolerance requirements, reliability requirements, data throughput requirements, mobility requirements, and the like. The CN 106/115 can provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 can be in direct or indirect communication with other RANs that employ the same RAT as the RAN 104/113 or a different RAT. For example, in addition to being connected to the RAN 104/113, which can be utilizing a NR radio technology, the CN 106/115 can also be in communication with another RAN (not shown) employing a GSM, UMTS, CDMA 2000, WiMAX, E-UTRA, or WiFi radio technology.

The CN 106/115 can also serve as a gateway for the WTRUs 102a, 102b, 102c, 102d to access the PSTN 108, the Internet 110, and/or the other networks 112. The PSTN 108 can include circuit-switched telephone networks that provide plain old telephone service (POTS). The Internet 110 can include a global system of interconnected computer networks and devices that use common communication protocols, such as the transmission control protocol (TCP), user datagram protocol (UDP) and/or the internet protocol (IP) in the TCP/IP internet protocol suite. The networks 112 can include wired and/or wireless communications networks owned and/or operated by other service providers. For example, the networks 112 can include another CN connected to one or more RANs, which can employ the same RAT as the RAN 104/113 or a different RAT.

One or more (e.g., all) of the WTRUs 102a, 102b, 102c, 102d in the communications system 100 can include multi-mode capabilities (e.g., the WTRUs 102a, 102b, 102c, 102d can include multiple transceivers for communicating with different wireless networks over different wireless links). For example, the WTRU 102c shown in FIG. 1A can be configured to communicate with the base station 114a, which can employ a cellular-based radio technology, and with the base station 114b, which can employ an IEEE 802 radio technology.

FIG. 1B is a system diagram illustrating an example WTRU 102. As shown in FIG. 1B, the WTRU 102 can include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 can include any sub-combination of the foregoing elements while remaining includeent with an embodiment.

The processor 118 can be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 can perform signal coding, data processing, power control, input/output processing, and/or any other functionality that enables the WTRU 102 to operate in a wireless environment. The processor 118 can be coupled to the transceiver 120, which can be coupled to the transmit/receive element 122. While FIG. 1B depicts the processor 118 and the transceiver 120 as separate components, it will be appreciated that the processor 118 and the transceiver 120 can be integrated together in an electronic package or chip.

The transmit/receive element 122 can be configured to transmit signals to, or receive signals from, a base station (e.g., the base station 114a) over the air interface 116. For example, in one embodiment, the transmit/receive element 122 can be an antenna configured to transmit and/or receive RF signals. In an embodiment, the transmit/receive element 122 can be an emitter/detector configured to transmit and/or receive IR, UV, or visible light signals, for example. In yet another embodiment, the transmit/receive element 122 can be configured to transmit and/or receive both RF and light signals. It will be appreciated that the transmit/receive element 122 can be configured to transmit and/or receive any combination of wireless signals.

Although the transmit/receive element 122 is depicted in FIG. 1B as a single element, the WTRU 102 can include any number of transmit/receive elements 122. More specifically, the WTRU 102 can employ MIMO technology. Thus, in one embodiment, the WTRU 102 can include two or more transmit/receive elements 122 (e.g., multiple antennas) for transmitting and receiving wireless signals over the air interface 116.

The transceiver 120 can be configured to modulate the signals that are to be transmitted by the transmit/receive element 122 and to demodulate the signals that are received by the transmit/receive element 122. As noted above, the WTRU 102 can have multi-mode capabilities. Thus, the transceiver 120 can include multiple transceivers for enabling the WTRU 102 to communicate via multiple RATs, such as NR and IEEE 802.11, for example.

The processor 118 of the WTRU 102 can be coupled to, and can receive user input data from, the speaker/microphone 124, the keypad 126, and/or the display/touchpad 128 (e.g., a liquid crystal display (LCD) display unit or organic light-emitting diode (OLED) display unit). The processor 118 can also output user data to the speaker/microphone 124, the keypad 126, and/or the display/touchpad 128. In addition, the processor 118 can access information from, and store data in, any type of suitable memory, such as the non-removable memory 130 and/or the removable memory 132. The non-removable memory 130 can include random-access memory (RAM), read-only memory (ROM), a hard disk, or any other type of memory storage device. The removable memory 132 can include a subscriber identity module (SIM) card, a memory stick, a secure digital (SD) memory card, and the like. In other embodiments, the processor 118 can access information from, and store data in, memory that is not physically located on the WTRU 102, such as on a server or a home computer (not shown).

The processor 118 can receive power from the power source 134, and can be configured to distribute and/or control the power to the other components in the WTRU 102. The power source 134 can be any suitable device for powering the WTRU 102. For example, the power source 134 can include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 can also be coupled to the GPS chipset 136, which can be configured to provide location information (e.g., longitude and latitude) regarding the current location of the WTRU 102. In addition to, or in lieu of, the information from the GPS chipset 136, the WTRU 102 can receive location information over the air interface 116 from a base station (e.g., base stations 114a, 114b) and/or determine its location based on the timing of the signals being received from two or more nearby base stations. It will be appreciated that the WTRU 102 can acquire location information by way of any suitable location-determination method while remaining consistent with an embodiment.

The processor 118 can further be coupled to other peripherals 138, which can include one or more software and/or hardware modules that provide additional features, functionality and/or wired or wireless connectivity. For example, the peripherals 138 can include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 can include one or more sensors, the sensors can be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 can include a full duplex radio for which transmission and reception of some or all of the signals (e.g., associated with particular subframes for both the UL (e.g., for transmission) and downlink (e.g., for reception) can be concurrent and/or simultaneous. The full duplex radio can include an interference management unit to reduce and or substantially eliminate self-interference via either hardware (e.g., a choke) or signal processing via a processor (e.g., a separate processor (not shown) or via processor 118). In an embodiment, the WTRU 102 can include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 can employ an E-UTRA radio technology to communicate with the WTRUs 102a, 102b, 102c over the air interface 116. The RAN 104 can also be in communication with the CN 106.

The RAN 104 can include eNode-Bs 160a, 160b, 160c, though it will be appreciated that the RAN 104 can include any number of eNode-Bs while remaining includeent with an embodiment. The eNode-Bs 160a, 160b, 160c can each include one or more transceivers for communicating with the WTRUs 102a, 102b, 102c over the air interface 116. In one embodiment, the eNode-Bs 160a, 160b, 160c can implement MIMO technology. Thus, the eNode-B 160a, for example, can use multiple antennas to transmit wireless signals to, and/or receive wireless signals from, the WTRU 102a.

Each of the eNode-Bs 160a, 160b, 160c can be associated with a particular cell (not shown) and can be configured to handle radio resource management decisions, handover decisions, scheduling of users in the UL and/or DL, and the like. As shown in FIG. 1C, the eNode-Bs 160a, 160b, 160c can communicate with one another over an X2 interface.

The CN 106 shown in FIG. 1C can include a mobility management entity (MME) 162, a serving gateway (SGW) 164, and a packet data network (PDN) gateway (or PGW) 166. While each of the foregoing elements are depicted as part of the CN 106, it will be appreciated that any of these elements can be owned and/or operated by an entity other than the CN operator.

The MME 162 can be connected to each of the eNode-Bs 162a, 162b, 162c in the RAN 104 via an S1 interface and can serve as a control node. For example, the MME 162 can be responsible for authenticating users of the WTRUs 102a, 102b, 102c, bearer activation/deactivation, selecting a particular serving gateway during an initial attach of the WTRUs 102a, 102b, 102c, and the like. The MME 162 can provide a control plane function for switching between the RAN 104 and other RANs (not shown) that employ other radio technologies, such as GSM and/or WCDMA.

The SGW 164 can be connected to each of the eNode Bs 160a, 160b, 160c in the RAN 104 via the S1 interface. The SGW 164 can generally route and forward user data packets to/from the WTRUs 102a, 102b, 102c. The SGW 164 can perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 can be connected to the PGW 166, which can provide the WTRUs 102a, 102b, 102c with access to packet-switched networks, such as the Internet 110, to facilitate communications between the WTRUs 102a, 102b, 102c and IP-enabled devices.

The CN 106 can facilitate communications with other networks. For example, the CN 106 can provide the WTRUs 102a, 102b, 102c with access to circuit-switched networks, such as the PSTN 108, to facilitate communications between the WTRUs 102a, 102b, 102c and traditional land-line communications devices. For example, the CN 106 can include, or can communicate with, an IP gateway (e.g., an IP multimedia subsystem (IMS) server) that serves as an interface between the CN 106 and the PSTN 108. In addition, the CN 106 can provide the WTRUs 102a, 102b, 102c with access to the other networks 112, which can include other wired and/or wireless networks that are owned and/or operated by other service providers.

Although the WTRU is described in FIGS. 1A-1D as a wireless terminal, it is contemplated that in certain representative embodiments that such a terminal can use (e.g., temporarily or permanently) wired communication interfaces with the communication network.

In representative embodiments, the other network 112 can be a WLAN.

A WLAN in Infrastructure Basic Service Set (BSS) mode can have an Access Point (AP) for the BSS and one or more stations (STAs) associated with the AP. The AP can have an access or an interface to a Distribution System (DS) or another type of wired/wireless network that carries traffic in to and/or out of the BSS. Traffic to STAs that originates from outside the BSS can arrive through the AP and can be delivered to the STAs. Traffic originating from STAs to destinations outside the BSS can be sent to the AP to be delivered to respective destinations. Traffic between STAs within the BSS can be sent through the AP, for example, where the source STA can send traffic to the AP and the AP can deliver the traffic to the destination STA. The traffic between STAs within a BSS can be considered and/or referred to as peer-to-peer traffic. The peer-to-peer traffic can be sent between (e.g., directly between) the source and destination STAs with a direct link setup (DLS). In certain representative embodiments, the DLS can use an 802.11e DLS or an 802.11z tunneled DLS (TDLS). A WLAN using an Independent BSS (IBSS) mode can not have an AP, and the STAs (e.g., all of the STAs) within or using the IBSS can communicate directly with each other. The IBSS mode of communication can sometimes be referred to herein as an “ad-hoc” mode of communication.

When using the 802.11ac infrastructure mode of operation or a similar mode of operations, the AP can transmit a beacon on a fixed channel, such as a primary channel. The primary channel can be a fixed width (e.g., 20 MHz wide bandwidth) or a dynamically set width via signaling. The primary channel can be the operating channel of the BSS and can be used by the STAs to establish a connection with the AP. In certain representative embodiments, Carrier Sense Multiple Access with Collision Avoidance (CSMA/CA) can be implemented, for example in in 802.11 systems. For CSMA/CA, the STAs (e.g., every STA), including the AP, can sense the primary channel. If the primary channel is sensed/detected and/or determined to be busy by a particular STA, the particular STA can back off. One STA (e.g., only one station) can transmit at any given time in a given BSS.

High Throughput (HT) STAs can use a 40 MHz wide channel for communication, for example, via a combination of the primary 20 MHz channel with an adjacent or nonadjacent 20 MHz channel to form a 40 MHz wide channel.

Very High Throughput (VHT) STAs can support 20 MHz, 40 MHz, 80 MHz, and/or 160 MHz wide channels. The 40 MHz, and/or 80 MHz, channels can be formed by combining contiguous 20 MHz channels. A 160 MHz channel can be formed by combining 8 contiguous 20 MHz channels, or by combining two non-contiguous 80 MHz channels, which can be referred to as an 80+80 configuration. For the 80+80 configuration, the data, after channel encoding, can be passed through a segment parser that can divide the data into two streams. Inverse Fast Fourier Transform (IFFT) processing, and time domain processing, can be done on each stream separately. The streams can be mapped on to the two 80 MHz channels, and the data can be transmitted by a transmitting STA. At the receiver of the receiving STA, the above described operation for the 80+80 configuration can be reversed, and the combined data can be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah can support Meter Type Control/Machine-Type Communications, such as MTC devices in a macro coverage area. MTC devices can have certain capabilities, for example, limited capabilities including support for (e.g., only support for) certain and/or limited bandwidths. The MTC devices can include a battery with a battery life above a threshold (e.g., to maintain a very long battery life).

WLAN systems, which can support multiple channels, and channel bandwidths, such as 802.11n, 802.11ac, 802.11af, and 802.11ah, include a channel which can be designated as the primary channel. The primary channel can have a bandwidth equal to the largest common operating bandwidth supported by all STAs in the BSS. The bandwidth of the primary channel can be set and/or limited by a STA, from among all STAs in operating in a BSS, which supports the smallest bandwidth operating mode. In the example of 802.11ah, the primary channel can be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings can depend on the status of the primary channel. If the primary channel is busy, for example, due to a STA (which supports only a 1 MHz operating mode), transmitting to the AP, the entire available frequency bands can be considered busy even though a majority of the frequency bands remains idle and can be available.

In the United States, the available frequency bands, which can be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 can employ an NR radio technology to communicate with the WTRUs 102a, 102b, 102c over the air interface 116. The RAN 113 can also be in communication with the CN 115.

The RAN 113 can include base stations 180a, 180b, 180c, though it will be appreciated that the RAN 113 can include any number of base stations while remaining includeent with an embodiment. The base stations 180a, 180b, 180c can each include one or more transceivers for communicating with the WTRUs 102a, 102b, 102c over the air interface 116. In one embodiment, the base stations 180a, 180b, 180c can implement MIMO technology. For example, base stations 180a, 108b can utilize beamforming to transmit signals to and/or receive signals from the base stations 180a, 180b, 180c. Thus, the base station 180a, for example, can use multiple antennas to transmit wireless signals to, and/or receive wireless signals from, the WTRU 102a. In an embodiment, the base stations 180a, 180b, 180c can implement carrier aggregation technology. For example, the base station 180a can transmit multiple component carriers to the WTRU 102a (not shown). A subset of these component carriers can be on unlicensed spectrum while the remaining component carriers can be on licensed spectrum. In an embodiment, the base stations 180a, 180b, 180c can implement Coordinated Multi-Point (COMP) technology. For example, WTRU 102a can receive coordinated transmissions from base station 180a and base station 180b (and/or base station 180c).

The WTRUs 102a, 102b, 102c can communicate with base stations 180a, 180b, 180c using transmissions associated with a scalable numerology. For example, the OFDM symbol spacing and/or OFDM subcarrier spacing can vary for different transmissions, different cells, and/or different portions of the wireless transmission spectrum. The WTRUs 102a, 102b, 102c can communicate with base stations 180a, 180b, 180c using subframe or transmission time intervals (TTIs) of various or scalable lengths (e.g., containing varying number of OFDM symbols and/or lasting varying lengths of absolute time).

The base stations 180a, 180b, 180c can be configured to communicate with the WTRUs 102a, 102b, 102c in a standalone configuration and/or a non-standalone configuration. In the standalone configuration, WTRUs 102a, 102b, 102c can communicate with base stations 180a, 180b, 180c without also accessing other RANs (e.g., such as eNode-Bs 160a, 160b, 160c). In the standalone configuration, WTRUs 102a, 102b, 102c can utilize one or more of base stations 180a, 180b, 180c as a mobility anchor point. In the standalone configuration, WTRUs 102a, 102b, 102c can communicate with base stations 180a, 180b, 180c using signals in an unlicensed band. In a non-standalone configuration WTRUs 102a, 102b, 102c can communicate with/connect to base stations 180a, 180b, 180c while also communicating with/connecting to another RAN such as eNode-Bs 160a, 160b, 160c. For example, WTRUs 102a, 102b, 102c can implement DC principles to communicate with one or more base stations 180a, 180b, 180c and one or more eNode-Bs 160a, 160b, 160c substantially simultaneously. In the non-standalone configuration, eNode-Bs 160a, 160b, 160c can serve as a mobility anchor for WTRUs 102a, 102b, 102c and base stations 180a, 180b, 180c can provide additional coverage and/or throughput for servicing WTRUs 102a, 102b, 102c.

Each of the base stations 180a, 180b, 180c can be associated with a particular cell (not shown) and can be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the base stations 180a, 180b, 180c can communicate with one another over an Xn interface.

The CN 115 shown in FIG. 1D can include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements can be owned and/or operated by an entity other than the CN operator.

The AMF 182a, 182b can be connected to one or more of the base stations 180a, 180b, 180c in the RAN 113 via an N2 interface and can serve as a control node. For example, the AMF 182a, 182b can be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing can be used by the AMF 182a, 182b in order to customize CN support for WTRUs 102a, 102b, 102c based on the types of services being utilized WTRUs 102a, 102b, 102c. For example, different network slices can be established for different use cases such as services relying on ultra-reliable low latency (URLLC) access, services relying on enhanced massive mobile broadband (eMBB) access, services for machine type communication (MTC) access, and/or the like. The AMF 162 can provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b can be connected to an AMF 182a, 182b in the CN 115 via an N11 interface. The SMF 183a, 183b can also be connected to a UPF 184a, 184b in the CN 115 via an N4 interface. The SMF 183a, 183b can select and control the UPF 184a, 184b and configure the routing of traffic through the UPF 184a, 184b. The SMF 183a, 183b can perform other functions, such as managing and allocating WTRU IP address, managing PDU sessions, controlling policy enforcement and QoS, providing downlink data notifications, and the like. A PDU session type can be IP-based, non-IP based, Ethernet-based, and the like.

The UPF 184a, 184b can be connected to one or more of the base stations 180a, 180b, 180c in the RAN 113 via an N3 interface, which can provide the WTRUs 102a, 102b, 102c with access to packet-switched networks, such as the Internet 110, to facilitate communications between the WTRUs 102a, 102b, 102c and IP-enabled devices. The UPF 184, 184b can perform other functions, such as routing and forwarding packets, enforcing user plane policies, supporting multi-homed PDU sessions, handling user plane QoS, buffering downlink packets, providing mobility anchoring, and the like.

The CN 115 can facilitate communications with other networks. For example, the CN 115 can include, or can communicate with, an IP gateway (e.g., an IP multimedia subsystem (IMS) server) that serves as an interface between the CN 115 and the PSTN 108. In addition, the CN 115 can provide the WTRUs 102a, 102b, 102c with access to the other networks 112, which can include other wired and/or wireless networks that are owned and/or operated by other service providers. In one embodiment, the WTRUs 102a, 102b, 102c can be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, base station 180a-c, AMF 182a-b, UPF 184a-b, SMF 183a-b, DN 185a-b, and/or any other device(s) described herein, can be performed by one or more emulation devices (not shown). The emulation devices can be one or more devices configured to emulate one or more, or all, of the functions described herein. For example, the emulation devices can be used to test other devices and/or to simulate network and/or WTRU functions.

The emulation devices can be designed to implement one or more tests of other devices in a lab environment and/or in an operator network environment. For example, the one or more emulation devices can perform the one or more, or all, functions while being fully or partially implemented and/or deployed as part of a wired and/or wireless communication network in order to test other devices within the communication network. The one or more emulation devices can perform the one or more, or all, functions while being temporarily implemented/deployed as part of a wired and/or wireless communication network. The emulation device can be directly coupled to another device for purposes of testing and/or can perform testing using over-the-air wireless communications.

The one or more emulation devices can perform the one or more, including all, functions while not being implemented/deployed as part of a wired and/or wireless communication network. For example, the emulation devices can be utilized in a testing scenario in a testing laboratory and/or a non-deployed (e.g., testing) wired and/or wireless communication network in order to implement testing of one or more components. The one or more emulation devices can be test equipment. Direct RF coupling and/or wireless communications via RF circuitry (e.g., which can include one or more antennas) can be used by the emulation devices to transmit and/or receive data.

The wireless communication system may include a terrestrial network (TN) and/or a non-terrestrial network (NTN), either or both of which may support coverage enhancements and/or broadcast services.

An NTN may be enhanced to support a TN-NTN deployment. An NTN capable WTRU may operate in the coverages of multiple (e.g., two) network layers, one of which may be based on an NTN and another one of which may be based on a TN. When referred to herein, a network layer may mean a single frequency layer, on which a communication network system may operate. The communication network system may be a TN, an NTN or any radio access technology (e.g., E-UTRA, NR, etc.).

A wireless communication network as described herein may include multiple layers. For example, terrestrial networks, low earth orbit (LEO) satellite networks, medium earth orbit (MEO) satellite networks and/or geostationary earth orbit (GEO) satellite networks may operate with different cell sizes and/or different over-the-air propagation delays. The GEO networks may have the largest cell coverage, with the longest propagation delay, followed by the MEO networks and the LEO networks (e.g., which may have smaller cell coverage and shorter propagation delays), and finally the terrestrial networks (e.g., which may have the smallest cell coverage but the shortest propagation delays).

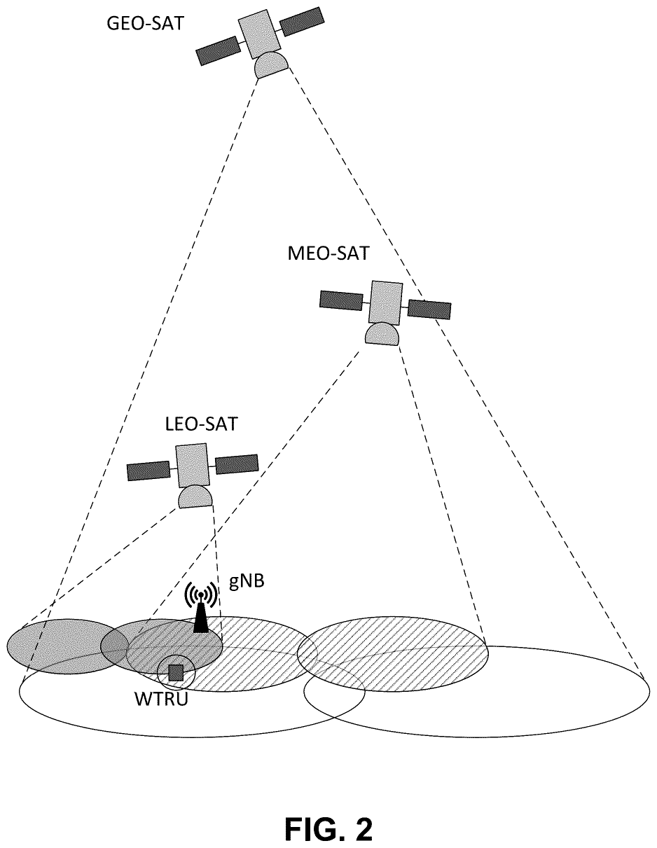

FIG. 2 illustrates examples of network layers (e.g., NTN and/or TN layers). The examples provided herein may refer to TN+NTN coverage, but those skilled in the art would appreciate that the principles disclosed herein may be applicable to any combination of network layers such as LEO+GEO, TN+MEO+GEO, TN lower frequency (e.g., FR1 or a frequency<=1 GHZ)+TN higher frequency (e.g., FR2 or a frequency>1 GHZ), and so on.

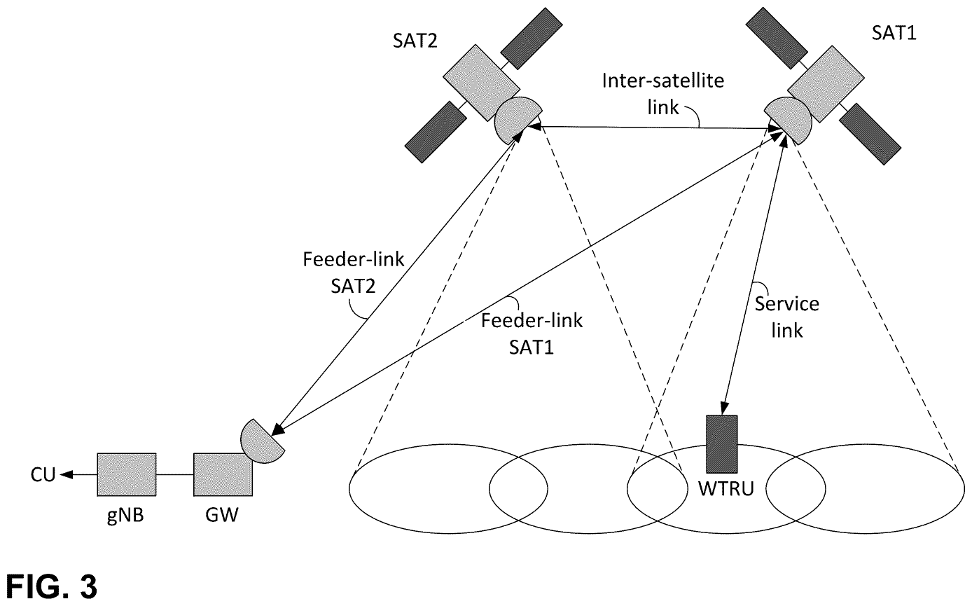

As illustrated in FIG. 3, several radio interfaces may be established in NTNs. For example, a feeder-link may refer to a wireless link between a satellite and a gateway. A service link may refer to a radio link between a satellite and a WTRU. An inter-satellite link (ISL) may refer to a transport link between satellites. The ISL may be supported by regenerative payloads. The ISL may be implemented using a radio or optical interface (e.g., a 3GPP radio or proprietary optical interface).

Different interfaces may be used for each radio link. The different interfaces may depend on the satellite payload configuration. For example, for a transparent payload, the NR-Uu radio interface may be used for the service link. In a transparent payload, the NR-Uu radio interface may be used for the feeder-link. For a regenerative payload, the NR-Uu interface may be used for the service link. For a retentive payload, a satellite radio interface (SRI) may be used for the feeder-link.

An NTN satellite may support multiple cells. Each cell may include one or more satellite beams. Satellite beams may cover a footprint on Earth (e.g., like a terrestrial cell). Satellite beams may range in diameter. For example, a satellite beam may range from 100-1000 km in LEO deployments. Beam footprints in LEO deployments may change over time due to satellite movement. A satellite beam may range from 200-3500 km diameter in GEO deployments. Beam footprints in GEO deployments may remain fixed relative to Earth. Beam movement may be classified as “Earth moving” (e.g., in LEO deployments where the beam moves continuously across the Earth). Beam movement may be classified as “Earth fixed” (e.g., in GEO deployments where the beam is steered to remain covering a fixed location until a new cell overtakes the coverage area).

The round-trip time (RTT) and maximum differential delay of NTNs may be larger than that of terrestrial systems. This may be due to the altitude of NTN platforms and beam diameter. For example, in a transparent NTN deployment, RTT can range from 25.77 milliseconds (e.g., for a LEO deployment at an altitude of 600 km) to 541.46 milliseconds (e.g., for a GEO deployment). The maximum differential delay in a transparent NTN deployment may range from 3.12 milliseconds to 10.3 milliseconds.

A wireless transmit/receive unit (WTRU) may provide Msg4 assistance information (e.g., in Msg3). The WTRU may receive system information from the network. The WTRU may provide the assistance information in Msg3 if the system information signals that the network expects the WTRU to provide the assistance information. The WTRU may check whether an assistance information transmission feature is available. The WTRU may determine the assistance information based on configuration(s) indicated by the system information. For example, the system information may provide reference signal received power (RSRP) thresholds for one or more (e.g., two) LCIDs (e.g., an RSRP threshold for each LCID, respectively). The WTRU may determine which LCID to use in Msg3 based on the measured RSRP value.

During initial access, the WTRU may provide Msg4 assistance information to the network. For example, the Msg4 assistance information may be provided through a physical uplink shared channel (PUSCH) transmission carrying Msg3 (e.g., an Msg3 PUSCH transmission). The Msg3 PUSCH transmission may include WTRU capability information, downlink (DL) signal levels, and/or the desired (e.g., required) number of Msg4 repetitions.

The WTRU may transmit Msg4 assistance information through one or more logical channel identifier (LCID) value(s) (e.g., in a medium access control (MAC) header of Msg3).

In examples, the Msg4 assistance information may be signaled in an Msg3 PUSCH by modifying one or more of the properties of the L1 signals (e.g., demodulation reference scheme (DMRS) sequence initialization, time/frequency location of DMRS, etc.).

A WTRU may determine the number of Msg4 repetitions transmitted by the network. The WTRU may determine the Msg4 transmission parameters (e.g., number of repetitions for Msg4 transmission) with or without the indication transmitted as part of the DCI scheduling Msg4 transmission. The WTRU may determine the Msg4 transmission parameters (e.g., number of repetitions for Msg4 transmission), for example, using implicit and/or explicit indication(s).

A WTRU may provide the assistance information for MsgB (e.g., while undergoing a 2-step RACH procedure). The WTRU may provide the assistance information for MsgB as part of a MsgA transmission. The WTRU may determine the assistance information for MsgB using any of the methods disclosed herein to determine the assistance information for Msg4. The WTRU may transmit assistance information through MsgA using any of the methods disclosed herein to transmit the assistance information as part of Msg3.

New radio (NR) non-terrestrial network (NTN) enhancements may address coverage limitation problems. For example, downlink coverage enhancements (DL-CE) may be applied to address coverage limitations. Physical downlink shared channel (PDSCH) transmissions carrying Msg4 (e.g., Msg4-PDSCH) may be associated with a large coverage gap.

PDSCH may be equipped with Msg4 link level enhancement(s). Feature(s) associated with PDSCH repetition are provided herein. Feature(s) associated with procedure and signaling are provided herein. Feature(s) associated with a repetition factor are provided herein.

In examples herein, the term “Msg3 PUSCH transmission” may refer to a PUSCH transmission carrying Msg3. In examples herein, the term “Msg4 PDSCH transmission” may refer to a PDSCH transmission carrying Msg4.

Coverage may be enhanced. A target carrier-to-noise ratio (CNR) may be −8 dB for NR NTN DL coverage enhancements at link level.

Msg4 PDSCH link level enhancement may be supported. For Msg4 PDSCH link level enhancement, Msg4 PDSCH repetition may be used (e.g., where the repetition factor is 2 or 4). To support the repetition of Msg4 PDSCH, a WTRU may report its request/capability of Msg4 PDSCH repetition (e.g., via Msg3 PUSCH), downlink control information (DCI) scheduling Msg4 PDSCH may indicate the repetition factor of Msg4 PDSCH (e.g., re-interpret DCI field, new RNTI, etc.).

A WTRU may report scheduling assistant information for assisting a network node (e.g., the gNB) scheduling of a Msg4 PDSCH repetition factor. Example information to be included in the assistant information is described herein. Example means for signaling the assistant information are provided herein.

Msg4-PDSCH repetition may be enabled. Msg4-PDSCH may be associated with a large coverage gap. The repetition of Msg4-PDSCH may be used to address the coverage gap.

Feature(s) associated with NR NTN initial access are provided herein. The transport block size (TBS) of Msg4 may be (e.g., assumed to be) 1040 bits (e.g., which implies that when using MCS0, 12 OS with 3 DMRS, the total number of needed PRBs is 42). In this case, there may be very little room to extend frequency resources. Time domain resource expansion may be used to improve coverage of PDSCH carrying Msg4.

Msg4-PDSCH may be improved through link level enhancement (e.g., due to the long distance of Uu interface, which refers to the radio interface between WTRU and gNB). If the network applies the link level enhancement to the Msg4-PDSCH transmission, the network may know (e.g., need to know) one or more of the following: whether the WTRU is capable of the link level enhancement; and/or where the WTRU may use (e.g., requires) the link level enhancement (e.g., depending on the WTRU's situation).

Msg1 or Msg3 may be used to carry this information to enable the Msg4-PDSCH repetition. Msg1 may not have spare space. Msg3 may have some (e.g., only 1-bit of) spare space.

DL repetitions may not be supported for Msg-4 PDSCH. A WTRU may signal a repetition request/capability message or scheduling assistance information (e.g., to a gNB).

Uplink signaling may enable Msg4-PDSCH repetition. However, there may be limited (e.g., only 1-bit) spare space in uplink signals prior to the Msg4 transmission in which to include the information to enable the repetition.

The WTRU may indicate its Msg4-PDSCH repetition capabilities. The WTRU may indicate that the WTRU is suffering from coverage limitation, and in examples, expects the gNB to repeat the Msg4-PDSCH. The assistance information may be included in Msg3 if (e.g., only if) the WTRU supports a feature (e.g., Msg4 PDSCH repetition).

A WTRU (e.g., an NTN WTRU) may provide assistance information, which may be associated with initial access. The assistance information may be described in examples herein as assistance information associated with assisting the network in providing a Msg 4 to the (e.g., where Msg 3 and Msg 4 may be used illustratively as examples of messages used in association with initial access). During initial access, the WTRU may provide Msg4 assistance information to the network through Msg3 PUSCH transmission. The assistance information may include (e.g., indicate) WTRU capability information and/or implicit/explicit transmission parameters for Msg4. The explicit transmission parameters for Msg4 may be number of Msg4 repetitions, a requested modulation and coding scheme, transmission over multiple slots, etc. The implicit assistance information for Msg4 may be DL measurements (e.g., RSRP value or RSRP value range). The DL measurements may allow the network to choose suitable transmission parameters for Msg4 transmission. The Msg4 assistance information may be indicated in Msg3 PUSCH by LCID value(s) (e.g., special LCID value(s), which may be indicated in a MAC header of the Msg3. The Msg4 assistance information may be indicated by modifying one or more properties of the L1 signals (e.g., DMRS sequence initialization, time/frequency location of DMRS, etc.).

A WTRU (e.g., an NTN WTRU) may perform initial access on a cell (e.g., an NR NTN cell), for example, after detecting the cell and acquiring system information). The system information may indicate that Msg4 PDSCH (e.g., a PDSCH transmission carrying Msg4) repetition is available at the NTN cell. The WTRU may determine the assistance information based on the condition(s)/configuration(s) indicated by the system information. For example, the LCID used in the Msg3 PDSCH transmission may be determined based on the measured RSRP value and given thresholds. In an example, DMRS (e.g., special DMRS) may be indicated in the Msg3 PDSCH transmission based on one or more measurement(s) and threshold(s).

The WTRU may receive a random access response (e.g., RAR, for example Msg2) carrying temporary C-RNTI and/or an UL grant for Msg3 PUSCH (e.g., in response to its PRACH transmission (Msg1).

The WTRU may determine whether the WTRU satisfies condition(s) based on one or more of the following. The WTRU may determine whether the WTRU satisfies the condition(s) based on WTRU capability (e.g., related to Msg4 PDSCH repetitions). The WTRU may determine and/or provide assistance information if (e.g., only if) the WTRU supports a given feature (e.g., Msg4 PDSCH repetitions).

The WTRU may determine the assistance information for Msg4 (e.g., the number of repetitions for Msg4 PDSCH) based on one or more of the following. The WTRU may determine the assistance information based on system information received from the cell. The WTRU may determine the assistance information based on DL measurements (e.g., reference signal received power (RSRP), reference signal received quality (RSRQ), etc. measured over DL transmissions of synchronization signal block (SSB), system information block 1 (SIB1), Msg2, etc.) being larger/smaller than thresholds. The WTRU may determine the assistance information based on WTRU determined/employed number of repetitions for physical random access channel (PRACH) and/or Msg3 PUSCH. The WTRU may determine the assistance information based on whether the cell is deploying a network energy saving or beam hopping mechanism. The WTRU may determine the assistance information based on whether the cell is operating with wide and narrow satellite beams (e.g., depending on whether the WTRU will receive Msg 4 through wide beam or narrow beam). The WTRU may determine the assistance information based on satellite ephemeris information (e.g., WTRU determining the elevation angle of the satellite at the WTRU location being smaller than a threshold).

The WTRU may signal (e.g., in the assistance information) whether the condition(s) are met in Msg3 (e.g., the LCID included in Msg3 may indicate whether the RSRP satisfies the threshold). The WTRU may indicate an expected number of repetitions (e.g., in the assistance information in Msg3).

The WTRU may transmit a Msg3 PUSCH to the network (e.g., in (e.g. via) the received RAR UL grant resource). The WTRU may provide the Msg4 assistance information in the Msg3 PUSCH. The Msg4 assistance information may include one or more of the following. The presence of the assistance information may indicate to the network that the WTRU supports one or more feature(s) (e.g., Msg4-PDSCH repetition). The Msg4 assistance information may include (e.g., indicate) WTRU capability information for Msg4 PDSCH repetitions (e.g., whether the WTRU is capable of receiving Msg4 PDSCH repetitions). The Msg4 assistance information may include an indication that the WTRU satisfies a given one or more conditions (e.g., the above conditions). The Msg4 assistance information may include (e.g., indicate) a level of radio condition at WTRU side (e.g., the WTRU measured RSRP or RSRQ is below or above a certain threshold). The Msg4 assistance information may include (e.g., indicate) a determined number of repetitions for Msg 4 reception (e.g., the WTRU determines a number of repetitions for Msg 4 to suggest to the gNB, where, in examples, the gNB may send the suggested number of Msg4 repetitions to the WTRU). The assistance information (e.g., LCID value or DMRS property) may be determined based on the WTRU location. For example, if the WTRU location is far from a cell center (e.g., a distance between the WTRU and the cell center is above a threshold), the WTRU may signal value X in the assistance information. The Msg4 assistance information may include (e.g., indicate) WTRU location information.

The Msg4 assistance information may be signaled over (e.g., sent via) one or more of the following. The Msg4 assistance information may be signaled using higher layer signaling. For example, the WTRU may select an LCID (e.g., a special LCID) value to include in a MAC sub-header of Msg3. The LCID value(s) may convey the Msg4 assistance information (e.g., according to a known condition(s)/configuration).

The Msg4 assistance information may be signaled over layer 1-based signaling. For example, the Msg4 assistance information may be signaled through one or more properties of the DMRS sequence in Msg3 PUSCH. For example, the Msg4 assistance information may be signaled during DMRS sequence initialization. The Msg4 assistance information may be indicated based on the cell ID and a delta value (e.g., where different delta values may convey the Msg4 assistance information according to the known condition(s)/configuration(s)). The Msg4 assistance information may be signaled during DMRS sequence initialization based on a temporary C-RNTI and a delta value (e.g., where different delta values may convey the Msg4 assistance information).

The Msg4 assistance information may be indicated based on a time position of OFDM symbols carrying DMRS. The Msg4 assistance information may be indicated based on frequency domain resource element locations carrying DMRS.

The Msg4 assistance information may be indicated based on the scrambling sequence used to scramble Msg3 PUSCH data. The cell ID and delta values may convey the Msg4 assistance information. The Msg4 assistance information may be indicated based on a temporary C-RNTI and delta values.

The WTRU may receive and decode DCI. The DCI may indicate the scheduling and/or repetition information for Msg4 PDSCH reception.

The WTRU may provide Msg4 assistance information without an increase of Msg3 payload. Without Msg4 assistance information, some WTRUs may not be able to perform initial access to the NTN cells.

A WTRU may provide Msg 4 assistance information to the network. The WTRU may receive system information from a cell. The WTRU may detect a cell. The cell may be a TN cell or an NTN cell. The WTRU may detect the cell based upon receiving synchronization signals from the cell. The synchronization signals may be part of the synchronization signal block (SSB). The WTRU may receive one or more SSBs through the cell (e.g., through different beams). The WTRU may use the SSB reception to perform time and frequency synchronization with the cell/beam used to transmit SSB.

The WTRU may determine to read system information (e.g., based on the received SSB). The WTRU may receive and decode system information block 1 (SIB1) through the cell. The WTRU may determine to read other SIBs (e.g., SIB19).

The WTRU may receive Msg4 relevant system information from a cell. The WTRU may receive and decode system information from a cell. The WTRU may receive system information relevant to perform initial access on the cell. The WTRU may detect system information associated with a RACH procedure. The RACH procedure may follow 2-step or 4-step RACH procedure. The WTRU may receive one or more of the following information associated with RACH access on the cell. The information may indicate that the cell is capable of transmitting Msg4 repetitions as part of 4-step RACH procedure. The information may indicate that the cell is capable of transmitting MsgB repetitions as part of 2-step RACH procedure. The information may indicate that the cell transmits a fixed number of Msg4 repetitions (e.g., 2 or 4). The information may indicate that the cell transmits a fixed number of Msg4 repetitions based upon cell configuration (e.g., narrow and wide beams). The cell may transmit a first number of repetitions when operating with narrow beams. The cell may transmit a second number of repetitions when operating with wide beams.

The information may indicate a request for the network to transmit Msg4 using the transmission parameters (e.g., Msg4 repetitions based on WTRU request). The information may indicate that the cell transmit Msg4 repetitions based on WTRU capability indication. The information may indicate that the cell transmits a minimum number ‘m’ of Msg4 repetitions. The information may indicate that the cell transmits a maximum number ‘M’ of Msg4 repetitions. The information may indicate that the cell transmits minimum number of Msg4 repetitions unless WTRU provides an indication to request higher number of repetitions. The information may indicate that the cell transmits a maximum number of Msg4 repetitions unless WTRU provides an indication to request lower number of repetitions. The information may indicate a threshold (e.g., RSRP value) to signal the first LCID value in Msg3. The information may indicate a threshold (e.g., RSRP value) to signal the second LCID value in Msg3.

The WTRU may determine Msg4 assistance information. The WTRU may determine assistance information for Msg4 reception. The assistance information for Msg4 reception may comprise of one or more parameters associated with Msg4 transmission. In examples, the assistance information may comprise parameters for MsgB reception.

The WTRU may determine one or more of the following parameters as part of Msg4 assistance information: an RSRP level based on DL measurements; a range of RSRP levels based on DL measurements; a number of Msg4 repetitions; a minimum number of Msg4 repetitions; a maximum number of Msg4 repetitions; a transport block size for Msg4; a modulation and coding scheme; whether to split the Msg4 transmission into more than one transport block; etc.

The WTRU may determine the assistance information for Msg4 reception based on one or more of the following. The WTRU may determine the assistance information for Msg4 reception based on system information received from the cell. The WTRU may determine the assistance information for Msg4 reception based on WTRU capability (e.g., related to Msg4 PDSCH repetitions). The WTRU may determine the assistance information for Msg4 reception based on DL measurements (e.g., RSRP, RSRQ, etc. measured over DL transmissions of SSB, SIB1, Msg2, etc.) satisfying (e.g., being larger/smaller) than a threshold. The WTRU may determine the assistance information for Msg4 reception based on a WTRU determined/employed number of repetitions for PRACH and/or Msg3 PUSCH. The WTRU may determine the assistance information for Msg4 reception based on whether the cell deploys a network energy saving or beam hopping mechanism. The WTRU may determine the assistance information for Msg4 reception based on whether the cell operates with wide and/or narrow satellite beams (e.g., where WTRU is supposed to receive Msg 4 through wide beam or narrow beam). The WTRU may determine the assistance information for Msg4 reception based on satellite ephemeris information (e.g., WTRU determining the elevation angle of the satellite at the WTRU location being smaller than a threshold).

In example, the WTRU may determine the Msg4 assistance information (e.g., the number of repetitions for Msg4) based on a WTRU-determine number of PRACH transmissions. For example, the WTRU may be configured to assume that it will use the same number of Msg4 repetitions as used for PRACH (e.g., Msg1 or MsgA) transmissions. In this case, the indication of the number of Msg4 repetitions (e.g., to the network) may be implicit based on the number of repetitions for PRACH.

The WTRU may transmit Msg4 assistance information. The WTRU may provide an indication of Msg4 assistance information to the network. The WTRU may provide the indication of Msg4 assistance information in an implicit or explicit manner.

In examples, the WTRU may provide an indication of Msg4 assistance information to the network in an implicit manner. For example, the WTRU may determine (e.g., through the received system information) that the network will transmit Msg4 with a configuration/parameter set. The WTRU may determine that this configuration/parameter set for Msg4 reception are acceptable for the WTRU.

In examples, the WTRU may provide an indication of Msg4 assistance information to the network in an explicit manner. The WTRU may transmit this indication to the network as part of the RACH procedure. The WTRU may transmit the Msg4 assistance information to the network as part of the UL signaling during the RACH procedure.

The WTRU may transmit Msg4 assistance information as L1 signaling in a PUSCH carrying Msg3 (e.g., Msg3 PUSCH).

A WTRU may transmit the Msg4 assistance information to the network. The WTRU may transmit the Msg4 assistance information to the network as part of a Msg3 PUSCH transmission. The WTRU may transmit the Msg4 assistance information to the network through higher layer and/or lower layer signaling as part of the Msg3 PUSCH transmission. The WTRU may transmit Msg3 PUSCH to the network in the received RAR UL grant resource.

The WTRU may transmit the Msg4 assistance information to the network through any of the following signaling methods.

The WTRU may transmit the Msg4 assistance information to the network through any of the properties of the DMRS sequence initialization in Msg3 PUSCH transmission. For example, he WTRU may transmit the Msg4 assistance information to the network through DMRS sequence initialization based on the cell ID and a delta value. Different delta values may convey the Msg4 assistance information according to known condition(s)/configuration. In examples, the WTRU may select the cell ID+{delta1, delta2, delta3} to initialize the DMRS sequence (e.g., where the cell ID is the physical cell identity of the cell and each of delta1, delta2, and delta3 are mapped to certain parameters of Msg4 assistance information). In examples, delta1, delta2, and delta3 may take the values 0, 1, and 2, respectively, and may be mapped to 1 repetition, 2 repetitions, and 4 repetitions for Msg4 transmission, respectively.

The WTRU may transmit the Msg4 assistance information to the network through DMRS sequence initialization based on temporary C-RNTI and a delta value. For example, different delta values may convey the Msg4 assistance information. The WTRU may transmit the Msg4 assistance information to the network through DMRS sequence initialization based on a combination and a delta value (e.g., where different delta values may convey the Msg4 assistance information).

The WTRU may transmit the Msg4 assistance information to the network through the time position of OFDM symbols carrying DMRS (e.g., where different time positions for DMRS symbols correspond to different Msg4 assistance information). The WTRU may transmit the Msg4 assistance information to the network through frequency domain resource element locations carrying DMRS (e.g., where different selection of resource elements for DMRS provides the Msg4 assistance information).

The WTRU may transmit the Msg4 assistance information to the network through the scrambling sequence used to scramble Msg3 PUSCH data. The WTRU may modify the initialization of the scrambling sequence such that the Msg4 assistance information is indicated to the network. The initialization of the scrambling sequence for Msg3 PUSCH may be based on RNTI (e.g., temporary C-RNTI received by the WTRU in Msg2-RAR, etc.) and/or cell ID. The WTRU may add a delta value to the initialization of the scrambling sequence from a set of delta values (e.g., {delta1, delta2, delta3} where the selected delta value corresponds to the Msg4 assistance information). The values for delta1, delta2, delta3, etc, and their mappings to different Msg4 assistance information parameters may be known to the WTRU (e.g., through specification or may be signaled to the WTRU as part of the system information).

The WTRU may transmit the Msg4 assistance information to the network through the CRC bits. In examples, the WTRU may transmit the Msg4 assistance information to the network through CRC parity bits. The WTRU may update, modify, or process the CRC bits so as to convey the Msg4 assistance information. In examples, the WTRU may add (e.g., through a modulo addition) a value from a set of {delta1, delta2, delta3} to the CRC bits before adding them to the transport block. In examples, the WTRU may choose different generator polynomials to compute CRC (e.g., where the choice of generator polynomial is based upon the Msg4 assistance information).

The WTRU may transmit the Msg4 assistance information as higher layer signaling in Msg3 PUSCH. The WTRU may transmit the Msg4 assistance information to the network. The WTRU may transmit the Msg4 assistance information to the network as part of Msg3 PUSCH transmission. The WTRU may transmit the Msg4 assistance information to the network through higher layer or lower layer signaling as part of the Msg3 PUSCH transmission. In examples, the WTRU may transmit the Msg4 assistance information the network through higher layer signaling as part of Msg3 PUSCH transmission. The WTRU may transmit the Msg4 assistance information through any one or more of the following techniques.

The WTRU may transmit the Msg4 assistance information through the WTRU selecting a (e.g., special) logical channel identifier (LCID) value in MAC sub-header. The (e.g., special) LCID value may convey the Msg4 assistance information according to the known condition(s)/configuration. For example, the WTRU may be configured to indicate one value from the set of LCID values, where the LCID values and their mappings to different MSg4 assistance information are part of the configuration. The WTRU may transmit one value based upon its determined Msg4 assistance information (e.g., indication of that measured RSRP is less than a given threshold or number of repetitions for Msg4 transmission).

The WTRU may transmit the Msg4 assistance information through an RRC message setup request message carried in Msg3 PUSCH. In examples, the WTRU may provide the information using the spare bit in the RRCSetupRequest message.

The WTRU may transmit the Msg4 assistance information through an RRC message setup request message carried in Msg3 PUSCH. The WTRU may transmit the Msg4 assistance information in the “EstablishmentCause”. In examples, the WTRU may provide the Msg4 information using the spare values in “EstablishmentCause”. For example, different spare values may be mapped to different parameters of Msg4 assistance information (e.g., spare1 value for 2 repetitions of Msg4, spare2 value for 4 repetitions of Msg4). The WTRU selection and indication of the value may convey the information to the network (e.g., when the network receives the corresponding spare value in “EstablishmentCause” from the WTRU).

The WTRU may transmit Msg4 assistance information through hybrid signaling. The WTRU may transmit the Msg4 assistance information to the network. The WTRU may transmit the Msg4 assistance information to the network through a combination of lower layer and higher layer signaling methods. The WTRU may be configured to partition the Msg4 assistance information in several partitions. For example, the Msg4 assistance information may be partitioned into a part associated to WTRU capability, a part associated to DL coverage status (e.g., based upon WTRU measurements on DL reference signals), a part associated to requested parameter sets for Msg4 transmission (e.g., requested number of Msg4 repetitions etc.), etc.

The WTRU may be provided with a mapping to transmit different parts of Msg4 assistance information through different signaling methods. For example, one part of Msg4 assistance information may be transmitted through DMRS based signaling, one part of Msg4 assistance information may be transmitted through scrambling, one part of Msg4 assistance information may be transmitted through the selection of logical channel ID, etc.

In examples, the WTRU may be configured to select hybrid signaling based on any one or more of the following: the number of Msg4 assistance information bits exceeds a threshold; the WTRU measurements for the DL coverage satisfy (e.g., fall below) a threshold, or fall in a specific range of thresholds; the network configures the hybrid signaling explicitly in the system information; and/or the like.

The WTRU may receive Msg4 with repetitions. The WTRU may receive Msg4 from the network. The WTRU may receive Msg4 from the network as part of RACH procedure. The WTRU may receive one or more repetitions of Msg4 from the network. The WTRU may determine the number of repetitions for Msg4 with or without the signaling carried in the DCI scheduling Msg4 transmission.

The WTRU may determine Msg4 transmission parameters. The WTRU may determine transmission parameters for Msg4 reception. The WTRU may determine any one or more of the following parameters for Msg4 reception: the number of Msg4 repetitions; the minimum number of repetitions for Msg4; the maximum number of repetitions for Msg4; a subset of (e.g., more than one) valid Msg4 repetition values from the set of allowed Msg4 repetition values (e.g., determining only [1, 2] are valid repetition values from the set of allowed repetitions [1, 2, 4, 8] values, etc.); a final value of Msg4 repetitions from a (sub) set of valid values (e.g., which is a subset of the allowed values); Msg4 transmission over multi-slot as transport block over multi-slot (TBoMS) based transmission; DMRS bundling applied to the transmission of Msg4 (e.g., when Msg4 transmission is using TBoMS); a redundancy version for Msg4 transmission; a sequence of redundancy versions for multiple repetitions for Msg4 transmission; a time resource for Msg4 repetitions (e.g., the WTRU may determine the time resource for multiple repetitions in the slots subsequent to the one indicated for Msg4 first repetition); a frequency resource for Msg4 repetitions (e.g., the WTRU may determine the frequency resource for the repetitions to be the same as the one indicated for the first repetition); and/or the like.

The WTRU may determine Msg4 transmission parameter(s) without a DCI based indication. The WTRU may determine transmission parameters for Msg4 reception. The WTRU may determine the transmission parameters for Msg4 (e.g., the number of repetitions, etc.) based on first information. The first information may refer to the information acquired by the WTRU without the signaling carried in the DCI that schedules Msg4 transmission. In this case, the WTRU determination may be based on one or more of the following first information.

The first information may include the system information providing network behavior for the Msg4 repetitions (e.g., as part of MIB and/or SIB1, etc.). The first information may include the system information indicating that the network will transmit a minimum or a maximum number of repetitions for Msg4.

The first information may include the number of PRACH repetitions transmitted by the WTRU The first information may include information in the Msg2 (e.g., based on the number of repetitions for Msg2, the information contents in Msg2, or an explicit indication in Msg2).

The WTRU may determine transmission parameters for Msg4 reception based on the cell belonging to a specific orbit (e.g., LEO/MEO/GEO, where the WTRU knows by configuration the number of Msg4 repetitions associated to different orbits).

The WTRU may determine transmission parameters for Msg4 reception based on whether the network uses wide/narrow beams and an association of different wide/narrow beams to a different number of Msg4 repetitions.

The first information may include the assistance information provided by the WTRU to the network. For example, the WTRU may be configured to assume that the network will transmit the same number of Msg4 repetitions as requested by the WTRU.

The WTRU may determine transmission parameters for Msg4 reception based on the number of repetitions of DCI scheduling Msg4. For example, the WTRU may determine a first number of repetitions for Msg4 if the WTRU detects Msg4 scheduling DCI without repetition. The WTRU may determine a second number of repetitions for Msg4 if the WTRU detects Msg4 scheduling DCI with repetitions.

The WTRU may determine Msg4 transmission parameters through a DCI based indication.

The WTRU may determine one or more parameters for Msg4 reception. The WTRU may determine the transmission parameters for Msg4 reception through second information. The second information may refer to the information received by the WTRU as part of the signaling in the DCI that schedules Msg4 transmission. In this case, the WTRU determination may be based on one or more of the following second information.

The second information may include a field in the DCI carrying the Msg4 repetitions

The second information may include a physical property of the DMRS of the DCI scheduling Msg4 transmission.

The second information may include the CRC bits of the DCI. For example, the network may indicate the number of repetitions for Msg4 by the use of a specific identity or process to compute CRC bits. In examples, the network may perform an operation (e.g., exclusive OR operation) of the CRC bits with the RNTI+{delta1, delta2, delta3}. The RNTI may correspond to the WTRU RNTI value transmitted in Msg3. The delta1, delta2 and delta3 values may be associated with different number of Msg4 repetitions.

The WTRU may determine Msg4 transmission parameters based on a hybrid approach. The WTRU may determine one or more parameters (e.g., number of repetitions, RV, RV sequence, etc.) for Msg4 reception.

The WTRU may determine the transmission parameters for Msg4 reception in a hybrid approach. For example, one or more parameters may be determined implicitly, while other parameters are determined based on explicit indication in the DCI scheduling Msg4. In examples, the WTRU may determine a transmission parameter for Msg4 reception in a two-step approach. In a first step, the WTRU may determine a range or a valid set of values for a Msg4-transmission-parameter (e.g., number of repetitions) from a bigger set based on the first information (e.g., where the first information includes one or more aspects described herein). In the second step, the WTRU may determine a value, from the set of values determined in the first step, based on the second information (e.g., where the second information includes one or more aspects described herein).

In examples, the WTRU may determine a set of permissible or allowed values (e.g., without DCI based indication). The DCI indication may provide an indication of the final value from the values determined by the WTRU. For example, the WTRU may know (e.g., through configuration) a set of values for Msg4 repetition. The value may be any of {1, 2, 4, 8}, for example. The WTRU may determine that a subset of values (e.g., only values [2, 4]) are valid for Msg4. The WTRU may determine the valid values based on a detected/received/indicated number of repetitions for DCI that schedules Msg4. A bit (e.g., a single bit) indication in DCI may be used to select a final value among the WTRU determined valid values.

SIB1 may be updated with the following additional information elements (IEs).

```
SIB1-v19XY-IEs ::=  SEQUENCE {
  ntn-ConfigSIB1-r19  NTN-ConfigSIB1-r19  OPTIONAL − Need R
}
NTN-ConfigSIB1-r19 ::=  SEQUENCE {
  rsrp-Threshold1  INTEGER  (−120—22) OPTIONAL − Need R
  rsrp-Threshold2  INTEGER  (−120—22) OPTIONAL − Need R
}
```

SIB1 field descriptions

rsrp-Threshold1
This IE specifies the RSRP threshold to signal the 1^{st} LCID value for the
Msg4-PDSCH repetition defined in 38.321 subclause 6.2.1. If the
measured RSRP value is less than the threshold, then the 1^{st} LCID value is
signalled when Msg3 is transmitted.
rsrp-Threshold2
This IE specifies the RSRP threshold to signal the 2^{nd} LCID value for the
Msg4-PDSCH repetition defined in 38.321 subclause 6.2.1. If the
measured RSRP value is less than the threshold, then the 2^{nd} LCID value
is signalled when Msg3 is transmitted.

LCID values may be defined as shown in Table 1.

TABLE 1
Values of LCID for DL-SCH

| Codepoint/Index | LCID values |
|---|---|
| 0 | CCCH |
| 1-32 | Identity of the logical channel of DCCH, DTCH and |
| | multicast MTCH |
| 33 | Extended logical channel ID field (two-octet eLCID |
| | field) |
| 34 | Extended logical channel ID field (one-octet eLCID |
| | field) |
| 35-44 | Reserved |
| 45 | The measured RSRP is less than the first threshold in |
| | Msg4-PDSCH repetition configuration |
| 46 | The measured RSRP is less than the second threshold |
| | in Msg4-PDSCH repetition configuration |
| 47 | Recommended bit rate |
| 48 | SP ZP CSI-RS Resource Set Activation/Deactivation |
| 49 | PUCCH spatial relation Activation/Deactivation |
| 50 | SP SRS Activation/Deactivation |
| 51 | SP CSI reporting on PUCCH Activation/Deactivation |
| 52 | TCI State Indication for WTRU-specific PDCCH |
| 53 | TCI States Activation/Deactivation for WTRU-specific |
| | PDSCH |
| 54 | Aperiodic CSI Trigger State Subselection |
| 55 | SP CSI-RS/CSI-IM Resource Set Activation/Deactiva- |
| | tion |
| 56 | Duplication Activation/Deactivation |
| 57 | SCell Activation/Deactivation (four octets) |
| 58 | SCell Activation/Deactivation (one octet) |
| 59 | Long DRX Command |
| 60 | DRX Command |
| 61 | Timing Advance Command |
| 62 | WTRU Contention Resolution Identity |
| 63 | Padding |

Disclosed herein are systems, methods, and instrumentalities associated with initial access procedure assistance information.

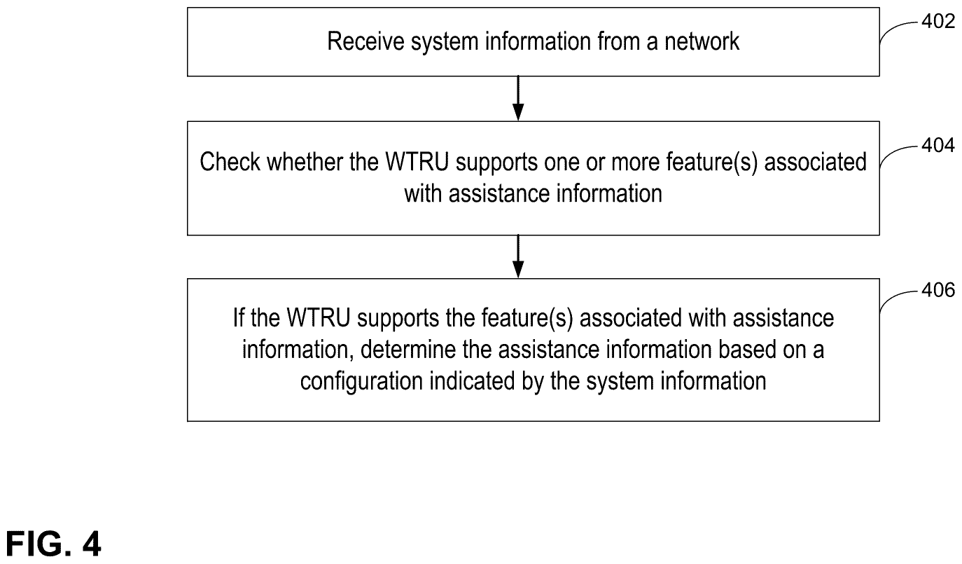

FIG. 4 illustrates an example of a WTRU determining assistance information based on condition(s)/configuration(s) indicated in system information. At 402, the WTRU may receive system information from the network. The WTRU may provide the assistance information in Msg3 if system information signals that the network expects the WTRU to provide the assistance information. At 404, the WTRU may check whether the WTRU supports one or more feature(s) associated with assistance information (e.g., whether the assistance information transmission feature is available, the WTRU is capable of receiving Msg3 PDSCH transmission repetitions, etc.). At 406, if the WTRU supports the feature(s) associated with assistance information, the WTRU may determine the assistance information based on configuration(s) indicated by the system information. For example, the system information may provide reference signal received power (RSRP) thresholds for one or more (e.g., two) LCIDs (e.g., an RSRP threshold for each LCID, respectively). The WTRU may determine which LCID to use in Msg3 based on the measured RSRP value.

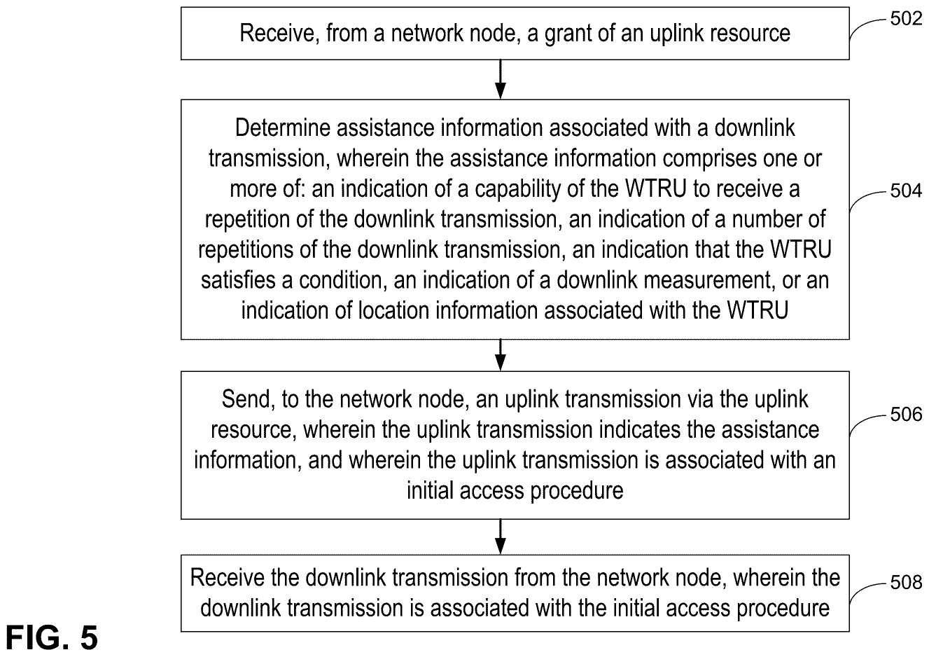

FIG. 5 illustrates an example of a WTRU sending initial access procedure assistance information, where one or more of the illustrated actions may be performed. At 502, the WTRU may be configured to receive, from a network node, a grant of an uplink resource. At 504, the WTRU may determine assistance information associated with a downlink transmission. The assistance information may include one or more of: an indication of a capability of the WTRU to receive a repetition of the downlink transmission, an indication of a number of repetitions of the downlink transmission, an indication that the WTRU satisfies a condition, an indication of a downlink measurement, or an indication of location information associated with the WTRU. At 506, the WTRU may send, to the network node, an uplink transmission via the uplink resource. The uplink transmission may indicate the assistance information. The uplink transmission may be associated with an initial access procedure. At 508, the WTRU may receive the downlink transmission from the network node. The downlink transmission may be associated with the initial access procedure.

The downlink transmission associated with the initial access procedure may include a physical downlink shared channel (PDSCH) transmission carrying Msg4. The uplink transmission may include a physical uplink shared channel (PUSCH) transmission carrying Msg3. The downlink transmission may be transmitted in accordance with the assistance information. For example, the network node may transmit repetitions of the downlink transmission (e.g., Msg4 PDSCH transmission) in accordance with the number of repetitions indicated in the assistance information.

The assistance information may indicate one or more of: a number of times to repeat the downlink transmission; a minimum number of times to repeat the downlink transmission; a maximum number of times to repeat the downlink transmission; that a reference signal received power (RSRP) level satisfies an RSRP threshold; that a reference signal received quality (RSRQ) level satisfies an RSRQ threshold; that the RSRQ level is within a range of RSRQ levels; a transport block size for the downlink transmission; a modulation and coding scheme; or whether to split the downlink transmission into more than one transport block.

The WTRU may determine the assistance information based on one or more of: system information received from the network node; a capability of the WTRU to receive repetitions of the downlink transmission; a downlink measurement satisfying a threshold; a number of repetitions associated with physical random access channel (PRACH) or physical uplink shared channel (PUSCH) transmissions; whether the network node is employing an energy saving mechanism; whether the network node is employing a beam hopping mechanism; whether the network node is operating with wide satellite beams; whether the network node is operating with narrow satellite beams; or satellite ephemeris information.

The uplink transmission may indicate the assistance information via: a delta value associated with demodulation reference signal (DMRS) sequence initialization; a time position of an orthogonal frequency division multiplexing (OFDM) symbol associated with DMRS; a location of a frequency domain resource element associated with DMRS; a scrambling sequence used to scramble data in the uplink transmission; or cyclic redundancy check (CRC) bits in the uplink transmission.

The uplink transmission may indicate the assistance information via: a logical channel identifier (LCID) in a medium access control (MAC) sub-header; a spare bit in a radio resource control (RRC) setup request message in the uplink transmission; or an establishment cause value in the RRC setup request message in the uplink transmission.

The assistance information may include first information and second information. The uplink transmission may indicate the first information via lower layer signaling. The uplink transmission may indicate the second information via higher layer signaling.

The initial access procedure may be a four-step random access channel procedure.

The WTRU may receive system information from the network. The WTRU may determine that the WTRU supports a feature associated with assistance information. The WTRU may determine the assistance information associated with the downlink transmission based on the system information.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor.

Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a solid state drive, register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, a terminal, a base station (e.g., a gNB), a control unit, a data unit, an RNC, and/or any host computer.

1. A wireless transmit/receive unit (WTRU), comprising:
a processor configured to:
receive, from a network node, a grant of an uplink resource;
determine assistance information associated with a downlink transmission, wherein the assistance information comprises one or more of: an indication of a capability of the WTRU to receive a repetition of the downlink transmission, an indication of a number of repetitions of the downlink transmission, an indication that the WTRU satisfies a condition, an indication of a downlink measurement, or an indication of location information associated with the WTRU;
send, to the network node, an uplink transmission via the uplink resource, wherein the uplink transmission indicates the assistance information, and wherein the uplink transmission is associated with an initial access procedure; and
receive the downlink transmission from the network node, wherein the downlink transmission is associated with the initial access procedure.

2. The WTRU of claim 1, wherein the downlink transmission associated with the initial access procedure comprises a physical downlink shared channel (PDSCH) transmission carrying Msg4, and wherein the uplink transmission comprises a physical uplink shared channel (PUSCH) transmission carrying Msg3.

3. The WTRU of claim 1, wherein the downlink transmission is transmitted in accordance with the assistance information.

4. The WTRU of claim 1, wherein the assistance information indicates one or more of:
a number of times to repeat the downlink transmission;
a minimum number of times to repeat the downlink transmission;
a maximum number of times to repeat the downlink transmission;
that a reference signal received power (RSRP) level satisfies an RSRP threshold;
that a reference signal received quality (RSRQ) level satisfies an RSRQ threshold;
that the RSRP level is within a range of RSRP levels;
that the RSRQ level is within a range of RSRQ levels;
a transport block size for the downlink transmission;
a modulation and coding scheme; or
whether to split the downlink transmission into more than one transport block.

5. The WTRU of claim 1, wherein the processor being configured to determine the assistance information comprises the processor being configured to determine the assistance information based on one or more of:
system information received from the network node;
a capability of the WTRU to receive repetitions of the downlink transmission;
a downlink measurement satisfying a threshold;
a number of repetitions associated with physical random access channel (PRACH) or physical uplink shared channel (PUSCH) transmissions;
whether the network node is employing an energy saving mechanism;
whether the network node is employing a beam hopping mechanism;
whether the network node is operating with wide satellite beams;
whether the network node is operating with narrow satellite beams; or
satellite ephemeris information.

6. The WTRU of claim 1, wherein the uplink transmission indicates the assistance information via:
a delta value associated with demodulation reference signal (DMRS) sequence initialization;
a time position of an orthogonal frequency division multiplexing (OFDM) symbol associated with DMRS;
a location of a frequency domain resource element associated with DMRS;
a scrambling sequence used to scramble data in the uplink transmission; or
cyclic redundancy check (CRC) bits in the uplink transmission.

7. The WTRU of claim 1, wherein the uplink transmission indicates the assistance information via:
a logical channel identifier (LCID) in a medium access control (MAC) sub-header;
a spare bit in a radio resource control (RRC) setup request message in the uplink transmission; or
an establishment cause value in the RRC setup request message in the uplink transmission.

8. The WTRU of claim 1, wherein the assistance information comprises first information and second information, the uplink transmission indicates the first information via lower layer signaling, and the uplink transmission further indicates the second information via higher layer signaling.

9. The WTRU of claim 1, wherein the initial access procedure comprises a four-step random access channel procedure.

10. The WTRU of claim 1, wherein the processor is further configured to:
receive system information from the network; and
determine that the WTRU supports a feature associated with assistance information, wherein the processor being configured to determine the assistance information associated with the downlink transmission comprises the processor being configured to determine the assistance information associated with the downlink transmission based on the system information.

11. A method, performed by a wireless transmit/receive unit (WTRU), the method comprising:
receiving, from a network node, a grant of an uplink resource;
determining assistance information associated with a downlink transmission, wherein the assistance information comprises one or more of: an indication of a capability of the WTRU to receive a repetition of the downlink transmission, an indication of a number of repetitions of the downlink transmission, an indication that the WTRU satisfies a condition, an indication of a downlink measurement, or an indication of location information associated with the WTRU;
sending, to the network node, an uplink transmission via the uplink resource, wherein the uplink transmission indicates the assistance information, and wherein the uplink transmission is associated with an initial access procedure; and
receiving the downlink transmission from the network node, wherein the downlink transmission is associated with the initial access procedure.

12. The method of claim 11, wherein the downlink transmission associated with the initial access procedure comprises a physical downlink shared channel (PDSCH) transmission carrying Msg4, and the uplink transmission comprises a physical uplink shared channel (PUSCH) transmission carrying Msg3.

13. The method of claim 11, wherein the downlink transmission is transmitted in accordance with the assistance information.

14. The method of claim 11, wherein the assistance information indicates one or more of:
a number of times to repeat the downlink transmission;
a minimum number of times to repeat the downlink transmission;
a maximum number of times to repeat the downlink transmission;
that a reference signal received power (RSRP) level satisfies an RSRP threshold;
that a reference signal received quality (RSRQ) level satisfies an RSRQ threshold;
that the RSRP level is within a range of RSRP levels;
that the RSRQ level is within a range of RSRQ levels;
a transport block size for the downlink transmission;
a modulation and coding scheme; or
whether to split the downlink transmission into more than one transport block.

15. The method of claim 11, wherein determining the assistance information comprises determining the assistance information based on one or more of:
system information received from the network node;
a capability of the WTRU to receive repetitions of the downlink transmission;
a downlink measurement satisfying a threshold;
a number of repetitions associated with physical random access channel (PRACH) or physical uplink shared channel (PUSCH) transmissions;
whether the network node is employing an energy saving mechanism;
whether the network node is employing a beam hopping mechanism;
whether the network node is operating with wide satellite beams;
whether the network node is operating with narrow satellite beams; or
satellite ephemeris information.

16. The method of claim 11, wherein the uplink transmission indicates the assistance information via:
a delta value associated with demodulation reference signal (DMRS) sequence initialization;
a time position of an orthogonal frequency division multiplexing (OFDM) symbol associated with DMRS;
a location of a frequency domain resource element associated with DMRS;
a scrambling sequence used to scramble data in the uplink transmission; or
cyclic redundancy check (CRC) bits in the uplink transmission.

17. The method of claim 11, wherein the uplink transmission indicates the assistance information via:
a logical channel identifier (LCID) in a medium access control (MAC) sub-header;
a spare bit in a radio resource control (RRC) setup request message in the uplink transmission; or
an establishment cause value in the RRC setup request message in the uplink transmission.

18. The method of claim 11, wherein the assistance information comprises first information and second information, the uplink transmission indicates the first information via lower layer signaling, and the uplink transmission further indicates the second information via higher layer signaling.

19. The method of claim 11, wherein the initial access procedure comprises a four-step random access channel procedure.

20. The method of claim 11, wherein the method further comprises:
receiving system information from the network; and
determining that the WTRU supports a feature associated with assistance information, wherein determining the assistance information associated with the downlink transmission comprises determining the assistance information associated with the downlink transmission based on the system information.
